(19) United States
(12) Patent Application Publication
(10) Pub. No.: US 2020/0013096 A1
(43) Pub. Date: Jan. 9, 2020

(54) Third-Party Service Portal-Initiated Garment Service Bag Issuance, Volumetrically-Standardized Pricing, and Matchmaking System for Professional Garment Cleaning

(71) Applicant: Sang Park, San Francisco, CA (US)

(72) Inventor: Sang Park, San Francisco, CA (US)

(21) Appl. No.: 16/029,590

(22) Filed: Jul. 7, 2018

(51) Int. Cl. G06Q 30/02; G06K 7/10

(52) U.S. Cl. CPC G06Q 30/0283; G06K 7/10366

(57) ABSTRACT

A novel electronic system for third-party service portal-initiated garment service bag creation, distribution, volumetrically-standardized pricing, and matchmaking of professional garment cleaning is disclosed. The novel electronic system physically issues and electronically tracks volumetrically-standardized online garment service bags that are shipped to potential customers, who can then utilize such service bags to load garments at volumetrically-standardized fees per service bag and transport to a plurality of independent local garment cleaning service providers subscribed to the third-party service portal. The novel electronic system also enables the plurality of independent local garment cleaning service providers to define and competitively offer garment cleaning service fees that are objectively price-comparable on a price-per-unit bag metric of laundry load due to the volumetric standardization and the pre-distribution of online garment service bags by the third-party service portal, even before the potential customers utilize such service bags to load and ship garments to garment cleaning service providers.

### BACKGROUND OF THE INVENTION

The present invention generally relates to electronic distribution and delivery systems and methods of operating such systems for garment cleaning services. More specifically, the present invention relates to third-party service portal-initiated garment service bag issuance, volumetrically-standardized pricing, and customer-to-provider matchmaking systems and also relates to methods of operating such systems that uniquely enable quantitatively-objective cost comparisons and efficient service executions among a plurality of independent local garment cleaning service providers.

Despite the ever-increasing popularity of Internet-based e-commerce in consumer purchasing patterns and behaviors in recent decades, many localized consumer service-oriented businesses remain disjointed or isolated from full e-commerce integration for their everyday commercial and transactional activities with their local consumers. For example, local plumbers, general construction contractors, dry cleaners, and home repair handymen do not typically rely on popular Internet e-commerce portal platforms, such as Amazon and eBay, to offer their localized consumer services for a variety of reasons that complicate their business conducts more complicated and less robust through online interfaces, compared to businesses that simply offer products and goods for sale.

In particular, commercial dry-cleaning, “wash-and-fold” laundry, and garment repair services offered in today's environment still heavily rely on face-to-face interactions between a garment cleaning/repair service provider and a prospective consumer over the cash register counter at a physical store. Although some garment cleaning service providers may have some online presence via individual websites, web advertising campaigns, and/or listing entries in Internet search engines, such online presence tends to be ineffective or disjointed to their everyday garment cleaning service cycles because the inherent dynamics of conventional garment cleaning operations necessitate a customer to bring his or her load of articles physically to a nearby garment cleaning service location. Shipping dirty laundry or garments to a local dry cleaner via conventional shipment methods (e.g. US postal service, UPS, FedEx, etc.) may be theoretically possible, but is generally considered too cumbersome, costly, and sluggish by most consumers, because a quick drive to a local dry cleaner to drop off their loads of garments for cleaning or repair is often deemed more convenient in most situations.

This often-necessary physical encounter between a customer and a garment cleaning service provider at the time of the garment load drop-off at a particular business address makes the garment cleaning service difficult to integrate into a conventional e-commerce shopping portal ecosystem, which is generally optimized for facilitating a business warehouse-to-customer's doorstep delivery of goods after the customer's online order confirmation. Not surprisingly, unlike businesses that sell and ship physical products, most garment cleaning service businesses are unable to cast a wide net outside of their immediate vicinities to attract potential customers, because they are unable to leverage from increasingly-powerful Internet portal ecosystems (e.g. Amazon Marketplace, eBay, etc.) that can provide a tremendous market exposure to a larger set of prospective customers with minimal or no additional marketing costs.

Furthermore, the local physical encounter-based customer interaction with a garment cleaning service provider presents significant challenges for service cost comparisons among multiple garment cleaning service providers in town. For example, a customer may simply be unaware of better pricing offered by other neighboring garment cleaning providers because many of these providers may lack robust online presence with pricing information. More importantly, even if the customer took painstaking measure to gather online and/or offline information in an attempt to compare garment cleaning service costs among multiple operators near his or her location, the basis of price comparisons may be often erroneous or misleading, because each provider often presents different measurements for service cost.

For example, a dry cleaner that offers $9.95 for cleaning a “large” piece of clothing and $5.95 for a “small” piece of clothing may or may not be cheaper than another dry cleaner that offers a flat price of $7.95 per dry-cleaned article. Likewise, a wash-and-fold laundry service that offers $14.95 for washing 20 pieces of clothing may or may not be cheaper than another commercial laundry service operator that offers a flat pricing of $19.95 for “one full load” of articles that goes into a washing machine. In the current state of the art, consumers are generally unable to quantify and synthesize objective price comparisons between one garment cleaning operator and another garment cleaning operator, thus making fair and informed price shopping difficult for their garment cleaning service needs.

Therefore, it may be advantageous to devise a novel electronic system that enables an Internet portal site to create volumetrically-standardized garment service bags and electronically track those bags through their lifecycles to facilitate, manage, and deliver garment cleaning services between consumers and local garment cleaning service providers. Furthermore, it may also be advantageous to devise a novel electronic system that facilitates and enforces volumetrically-standardized pricing and delivery for garment cleaning and repair services among a plurality of localized garment cleaning service providers. Moreover, it may also be advantageous to devise a method of operating such novel electronic systems to create and manage a robust e-commerce ecosystem of local and independent garment cleaning service providers that benefit from an expanded customer base reached by a third-party Internet portal site, even when no extra marketing expenses are incurred by the local and independent garment cleaning service providers.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a third-party service portal-initiated garment service bag issuance, volumetrically-standardized pricing, and matchmaking system for professional garment cleaning is disclosed. This system comprises: a volumetrically-standardized online garment service bag created and issued by a third-party service portal, wherein the volumetrically-standardized online garment service bag is mailed to a garment cleaning customer's physical address upon request by the garment cleaning customer via a customer user interface connected to the third-party service portal; a third-party service portal-side electronic subsystem in the third-party service portal comprising an online garment service bag issuance and shipment module configured to create, issue, and ship the volumetrically-standardized online garment service bag upon request by the garment cleaning customer, a professional garment cleaning service customer matchmaking module for independent local garment cleaning service providers, a price bidding module for the independent local garment cleaning service providers, a first user interface management module for the independent local garment cleaning service providers, a second user interface management module for the garment cleaning customer, and an online garment service bag issuance database; a first local garment cleaning service provider subsystem that allows a first independent local garment cleaning service provider to configure a first garment cleaning service fee for the volumetrically-standardized online garment service bag in the third-party service portal; a second local garment cleaning service provider subsystem that allows a second independent local garment cleaning service provider to configure a second garment cleaning service fee for the volumetrically-standardized online garment service bag in the third-party service portal, wherein the first garment cleaning service fee from the first local garment cleaning service provider subsystem and the second garment cleaning service fee from the second local garment cleaning service provider subsystem are directly comparable per unit bag type of loaded garments for objectively determining loaded garment cleaning service price differences; a customer subsystem configured to generate the customer user interface connected to the third-party service portal, wherein the customer user interface allows the garment cleaning customer to compare the first garment cleaning service fee and the second garment cleaning service fee per unit bag type of loaded garments in the volumetrically-standardized online garment service bag, before selecting a chosen independent local garment cleaning provider to initiate transportation of the volumetrically-standardized online garment service bag loaded with garments; a delivery provider subsystem configured to transport the volumetrically-standardized online garment service bag between the garment cleaning customer and the chosen independent local garment cleaning provider; and a data network operatively connecting the third-party service portal-side electronic subsystem, the first local garment cleaning service provider subsystem, the second local garment cleaning service provider subsystem, the customer subsystem, and the delivery provider subsystem, wherein at least one subsystem is executed on a CPU and a memory unit of a computer server or a portable electronic device.

### BRIEF DESCRIPTION OF DRAWINGS

FIG. 1 shows a third-party service portal-initiated garment service bag issuance, volumetrically-standardized pricing, and matchmaking system for professional garment cleaning, in accordance with an embodiment of the invention.

FIG. 2 shows a third-party service portal-issued and volumetrically-standardized online garment service bag incorporating a smart tag containing a customer order, a bag owner's ID, and garment cleaning service provider's feedback that are configurable and readable via a mobile application executed on a portable electronic device integrating a wireless tag reader, in accordance with an embodiment of the invention.

FIG. 3 shows a screenshot from an independent local garment service provider's user interface for garment cleaning service price bidding, service availability, and business contact updates to the third-party service portal-initiated garment service bag issuance, volumetrically-standardized pricing, and matchmaking system, in accordance with an embodiment of the invention.

FIG. 4 shows a screenshot from a potential customer's user interface originating from the third-party service portal-initiated garment service bag issuance, volumetrically-standardized pricing, and matchmaking system, in accordance with an embodiment of the invention.

FIG. 5 shows information stored in an online garment service bag issuance database and/or an electronic information storage and communication interface on the online garment service bag, in accordance with an embodiment of the invention.

FIG. 6 shows a method of operating a third-party service portal-initiated garment service bag issuance, volumetrically-standardized pricing, and matchmaking system, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more systems and methods for third-party service portal-initiated garment service bag issuance, volumetrically-standardized pricing, and matchmaking of independent local garment cleaning services and prospective customers. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of an embodiment of the present invention is to provide a novel third-party service portal-initiated electronic system that enables an Internet portal site to create volumetrically-standardized garment service bags and electronically track those bags through their lifecycles to facilitate, manage, and deliver garment cleaning services between consumers and local garment cleaning service providers.

Another objective of an embodiment of the present invention is to provide a novel third-party service portal-initiated electronic system that facilitates and enforces volumetrically-standardized pricing, volumetrically-standardized online garment service bags, and bilateral deliveries of laundry loads or dry-cleaning loads between independent local garment cleaning service providers and customers.

In addition, another objective of an embodiment of the present invention is to provide a method of operating a novel third-party service portal-initiated electronic system to create and manage a robust e-commerce ecosystem of local and independent garment cleaning service providers that benefit from an expanded customer base reached by a third-party Internet portal site, even when no extra marketing expenses are incurred by the local and independent garment cleaning service providers.

For the purpose of describing the invention, a term referred to as “garment service bag” is defined as a physical container, a physical basket, or a physical bag designed and manufactured specifically to place and contain a load of laundry, garments, and/or textiles that require professional cleaning or repair service, when requested by a customer. A garment service bag may be made of flexible or rigid materials, such as synthetic fibers, cotton, plastic, rubber, or a combination thereof. In a preferred embodiment of the invention, a “volumetrically-standardized online” garment service bag refers to a physical container, a physical basket, or a physical bag manufactured and/or issued by a third-party Internet portal site operator for a wide distribution to a plurality of garment cleaning customers and independent local garment cleaning service providers, wherein the volumetric standardization of each garment service bag allows an objective service price comparisons among numerous independent local garment cleaning service providers subscribed to the third-party Internet portal site on a novel metric defined herein as “price-per-unit bag type of laundry load.” The unit bag type may further be defined in terms of square meters or gallons. For example, a “Unit A” bag may be a 20-gallon worth of laundry load, while a “Unit B” bag may be a 35-gallon worth of laundry load, wherein each local garment cleaning service provider may set a particular service price for a particular unit bag type. Because each bag type is volumetrically-standardized and pre-distributed by the third-party Internet portal site to potential customers, both customers and local garment cleaning service providers subscribed to the third-party Internet portal site are able to compare price offerings in an objective and standardized scale, without price subjectivity and confusions that are rampant in conventional garment cleaning service methods.

Furthermore, in the preferred embodiment of the invention, the garment service bag may be an electronically-identifiable physical container unit incorporating a fixed or detachable electronic information storage and a communication interface, which can be accessed by another electronic device for information reading, writing, and/or updating. For example, a third-party service portal-issued online garment service bag embeds a non-volatile memory (e.g. Flash memory) storage and one or more wired (e.g. USB, serial port) and/or wireless (e.g. Bluetooth, IEEE 802.11 Standard-based wireless LAN, RFID, NFC, ZigBee) communication interfaces for access by customers' or garment cleaning providers' electronic devices. In another example, a third-party service portal-issued online garment service bag attaches or incorporates an RFID tag, which can be accessed by the customers' or the garment cleaning providers' electronic devices (e.g. smart phones, tablet computers, notebook computers, etc.) that execute online garment service bag reader mobile apps developed by the third-party service portal. In the preferred embodiment of the invention, the non-volatile memory storage or the RFID tag may store or update bag tag ID's, bag-issuance customer information, cleaning transaction information, bag location and status information, and bag unit types.

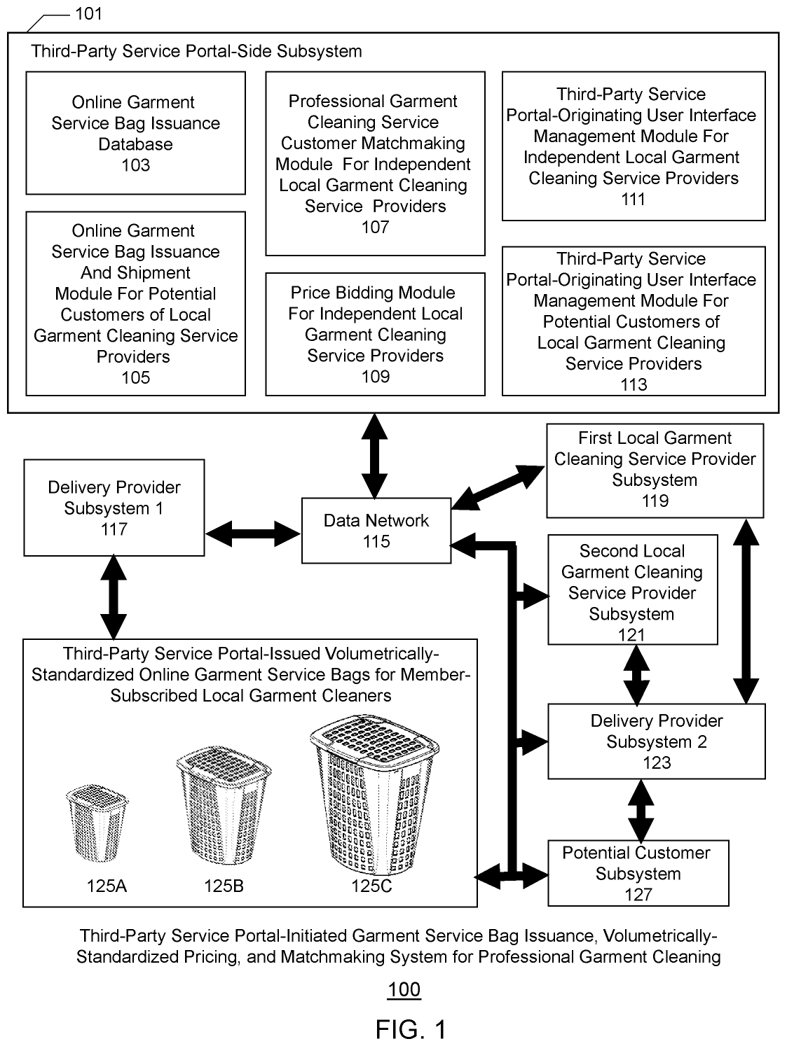

FIG. 1 shows a third-party service portal-initiated garment service bag issuance, volumetrically-standardized pricing, and matchmaking system (100) for professional garment cleaning, in accordance with an embodiment of the invention. In a preferred embodiment of the invention, the third-party service portal-initiated garment service bag issuance, volumetrically-standardized pricing, and matchmaking system (100) comprises a third-party service portal-side subsystem (101), a first delivery provider subsystem (117), a first local garment cleaning service provider subsystem (119), a second local garment cleaning service provider subsystem (121), a second delivery provider subsystem (123), a customer subsystem (127), one or more third-party service portal-issued volumetrically-standardized online garment service bags for member-subscribed local garment cleaners (125A, 125B, 125C), and a data network (115) operatively connecting various components and subsystems for communicating garment service bag issuance, tracking, transport, transaction, and garment cleaning or repair information among a third-party service portal, a plurality of local garment cleaning service providers subscribed to the third-party service portal, and a garment cleaning customer accessing the third-party service portal to request garment cleaning or repair service.

In the preferred embodiment of the invention, the third-party service portal-side subsystem (101) comprises an online garment service bag issuance database (103), an online garment service bag issuance and shipment module for customers of local garment cleaning service providers (105), a professional garment cleaning service customer matchmaking module (107) for independent local garment cleaning service providers, a price bidding module (109) for independent local garment cleaning service providers, a third-party service portal-originating user interface management module for independent local garment cleaning service providers (111), and a third-party service portal-originating user interface management module for customers of local garment cleaning service providers (113).

Continuing with the embodiment of the invention as shown in FIG. 1, the online garment service bag issuance and shipment module (105) is configured to create, issue, and ship one or more third-party service portal-issued volumetrically-standardized online garment service bags (125A, 125B, 125C) upon request by the garment cleaning customer. Typically, when the garment cleaning customer expresses interest in utilizing the third-party service portal to select a local garment cleaning service provider for garment cleaning and/or repair needs, the online garment service bag issuance and shipment module (105) executed by the third-party service portal-side subsystem (101) initializes a volumetrically-standardized online garment service bag (125A, 125B, or 125C) by synthesizing and assigning a bag tag ID, bag-issuance customer information, a bag location and status information, and a bag unit type, which indicates a novel online garment service pricing metric defined herein as “price-per-unit bag type of laundry load.” In context of this embodiment of the invention, the initial creation and the assignment of various online garment service bag-related data parameters (e.g. 501, 503, 505, 507, 509) are called an “online garment service bag issuance activity.” During the online garment service bag issuance activity, various online garment service bag-related data parameters are stored in the online garment service bag issuance database (103), which are then dynamically updated over time, as each online garment service bag gets involved in repeated garment cleaning or repair transactions back and forth among the third-party service portal, the garment cleaning customer, and various local garment cleaning service providers subscribed to the third-party service portal.

After the online garment service bag issuance is completed by the third-party service portal-side subsystem (101), the volumetrically-standardized online garment service bag (125A, 125B, or 125C) is physically transported from a warehouse managed by the third-party service portal to the garment cleaning customer, while shipment-related parameters (e.g. bag-issuance customer information, a bag location and status information, etc.) are dynamically updated by the first delivery provider subsystem (117) and the customer subsystem (127). In one embodiment of the invention, the first delivery provider subsystem (117) uploads the garment cleaning customer's delivery address in its shipment logistics database to enable a shipping company (e.g. FedEx, UPS, USPS, etc.) to route and deliver the volumetrically-standardized online garment service bag (125A, 125B, or 125C) from the warehouse to the garment cleaning customer's address, which was dynamically paired with the corresponding bag ID during the online garment service bag issuance activity.

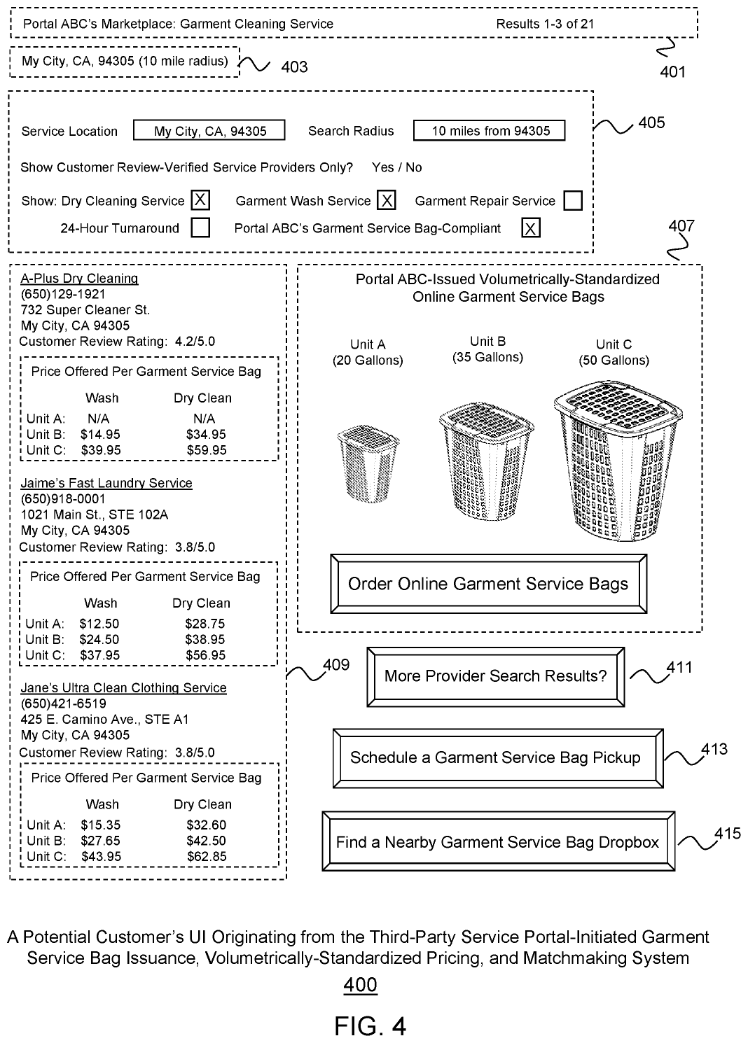

Once the garment cleaning customer receives the volumetrically-standardized online garment service bag (125A, 125B, or 125C) from the third-party service portal, the garment cleaning customer can utilize the customer subsystem (127) to execute a customer user interface on a web browser or on a mobile app to access and log into the third-party service portal via the data network (115). Preferably, the customer subsystem (127) comprises a customer's user interface computer application program or a similar mobile application program executed on a CPU and a memory unit of an electronic device. Each program originates (i.e. via downloads and/or synchronization with the third-party service portal-side subsystem (101)) from the user interface management module (113) for potential customers in the third-party service portal-side subsystem (101), which provides a customer user interface to access and review a localized list of garment service providers with objectively-comparable standardized prices based on a novel garment service pricing metric of “price-per-unit bag type of laundry load” across numerous localized garment cleaning service offerings. The customer's user interface computer application program or the mobile application program is typically executed on a smart phone, a tablet computer, a notebook computer, or a PC operated by the garment cleaning customer. In addition, the customer subsystem (127) also enables the garment cleaning customer to order third-party service portal-issued volumetrically-standardized online garment service bags from the third party service portal at a nominal fee or for free, while also allowing the garment cleaning customer to select a particular garment service offering, schedule a garment service bag pickup, or find a nearby garment service bag drop box, as illustrated in FIG. 4.

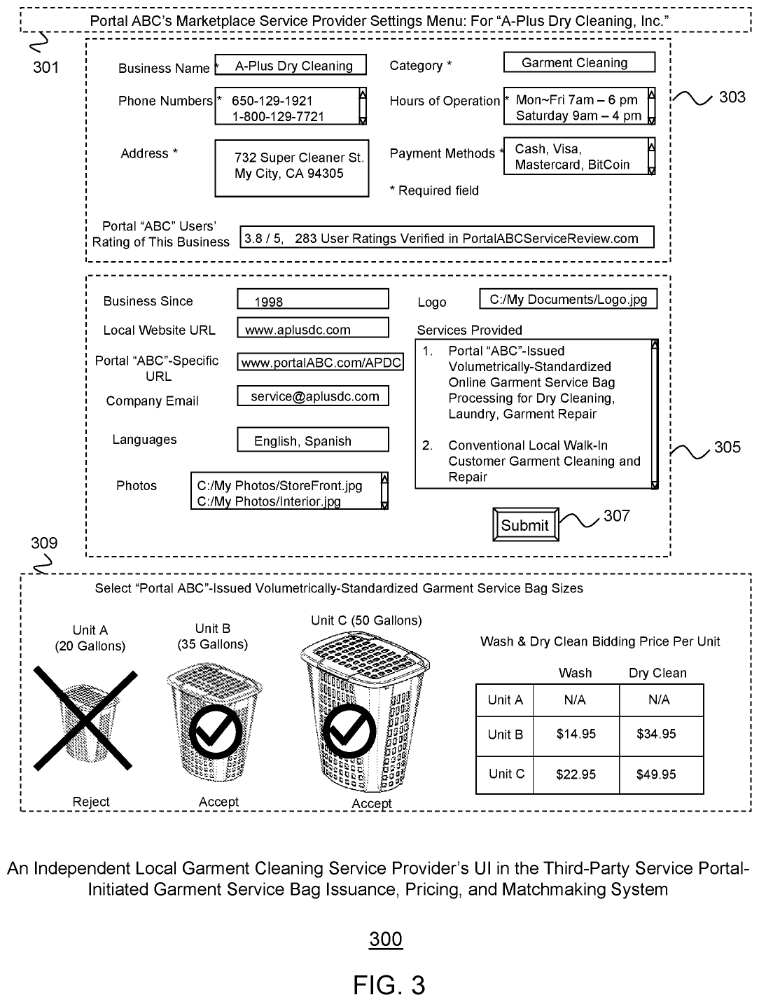

Continuing with the embodiment of the invention as shown in FIG. 1, the customer subsystem (127) and the third-party service portal-side system (101) are also operatively connected to the first local garment cleaning service provider subsystem (119), the second local garment cleaning service provider subsystem (121), and the second delivery provider subsystem (123). As exemplified by a user interface screenshot example (300) in FIG. 3, each local garment cleaning service provider subsystem (119 or 121) provides an electronic user interface to define and adjust a garment cleaning service fee for a particular volumetrically-standardized unit bag type of laundry load (e.g. 125A, 125B, or 125C), which is universally and uniformly volumetrically-standardized across a plurality of local garment cleaning service providers that are subscribed members to the third-party service portal. This universal volumetric standardization of online garment service bags among the plurality of local garment cleaning service providers subscribed to the third-party service portal enables objective and apples-to-apples garment cleaning and repair service offering possible, when potential customers search for dry-cleaning, wash-and-fold, and/or garment repair services among numerous local garment cleaning service providers.

In the preferred embodiment of the invention, each local garment cleaning service provider can elect to accept or reject certain volumetric types of online garment service bags and competitively adjust its price offerings based on dynamically-changing market conditions. For example, a first local garment cleaning service provider accessing the first local garment cleaning subsystem (121) may initially set a first garment cleaning service fee for a volumetrically-standardized online garment service bag (e.g. 125A, 125B, or 125C). Upon inspecting the first local garment cleaning service provider's pricing schemes on the third-party service portal, a second local garment cleaning service provider may then competitively set a second garment cleaning service fee via the second local garment cleaning service provider subsystem (121) for the same unit bag type of laundry load, which has been volumetrically-standardized by pre-distribution of online garment service bags by the third-party service portal, even before any garment cleaning service is rendered by local garment cleaning service providers. Subsequently, the first local garment cleaning service provider or another local garment cleaning service provider may lower or raise service prices, depending on the number of local service providers and the competitive nature of the industry in a particular period. Because the service price offering has been volumetrically-standardized across all subscribed garment cleaning service providers by a novel metric called “price-per-unit bag type of laundry load,” with online garment service bags pre-distributed to potential customers by the third-party service portal before any garment cleaning service are rendered by the subscribed garment cleaning service providers, potential customers can objectively and readily determine “apples-to-apples” price offering differences among the plurality of garment cleaning service providers in their preferred localities.

Preferably, each of the first local garment cleaning service provider subsystem (119) and the second local garment cleaning service provider subsystem (121) comprises a local garment cleaning service provider's computer application program or a similar mobile application program executed on a CPU and a memory unit of an electronic device. Each program originates (i.e. via downloads and/or synchronization with the third-party service portal-side subsystem (101)) from the user interface management module (111) for independent local garment cleaning service providers in the third-party service portal-side subsystem (101), which generates, manages, and/or updates an independent local garment service provider's user interface to initialize, define, select, and/or update business information, acceptable third-party service portal-issued unit bag types, and garment cleaning bidding price information for each accepted third-party service portal-issued unit bag type. The local garment cleaning service provider's computer application program or the similar mobile application program is typically executed on a smart phone, a tablet computer, a notebook computer, or a PC operated by a local garment cleaning service provider. Furthermore, the garment cleaning bidding price information entered by a particular local garment cleaning service provider is an objectively-comparable standardized price based on a novel garment service pricing metric of “price-per-unit bag type of laundry load,” wherein the pricing metric is managed and enforced by the third-party service portal via pre-distribution of online garment service bags unitized by volume among all subscribed local garment cleaning service providers, even before any garment cleaning services are initiated or offered on the third-party service portal.

Continuing with the embodiment of the invention as shown in FIG. 1, the third-party service portal-side subsystem (101) further includes the professional garment cleaning service customer matchmaking module (107) for independent local garment cleaning service providers, which is able to synthesize, match, and store client service transaction information between the garment cleaning customer and a customer-selected independent local garment cleaning service provider in the online garment service bag issuance database (103) based on customer-selected parameters in the customer user interface displayed by the customer subsystem (127). In addition, the third-party service portal-side subsystem (101) also includes the price bidding module (109) for independent local garment cleaning service providers. In the preferred embodiment of the invention, the price bidding module (109) allows each independent local garment cleaning service provider to initialize or adjust a garment cleaning service fee competitively based on comparisons with other providers' pricing information. In context of the third-party service portal's subscribed local business ecosystem, the pricing information for garment cleaning services is universally volumetrically-standardized per unit bag type of loaded garments in the volumetrically-standardized online garment service bag issued and managed by the third-party service portal.

In the preferred embodiment of the invention, the third-party service portal-side subsystem (101) is executed on a CPU and a memory unit of a computer server or a portable electronic device. Furthermore, various subsystems (i.e. 101, 117, 119, 121, 123, 127) and one or more third-party service portal-issued volumetrically-standardized online garment service bags (125A, 125B, 125C) in the third-party service portal-initiated garment service bag issuance, volumetrically-standardized pricing, and matchmaking system (100) are configured to transfer and communicate garment cleaning service-related transaction, status, and delivery information via the data network (115). Moreover, the data network (115) for the third-party service portal-initiated garment service bag issuance, volumetrically-standardized pricing, and matchmaking system (100) may be based on one or more wired, wireless, satellite communication protocols.

In context of the embodiment of the invention as shown in FIG. 1, after the garment cleaning customer selects a particular local garment cleaning service provider for his or her garment cleaning or repair needs from the customer user interface displayed by the customer subsystem (127), the volumetrically-standardized online garment service bag loaded with dirty or repair-needing clothing or other fabric items is transported to the particular (i.e. chosen) local garment cleaning service provider via the second delivery provider subsystem (123). The second delivery provider subsystem (123) may utilize a bag pickup service, a bag drop-off service, a door-to-door deliver service, or another delivery method to transport dirty, cleaned, and/or repaired garments contained in the volumetrically-standardized online garment service bag between the garment cleaning customer and the chosen local garment cleaning service provider, while recording and updating pertinent garment cleaning service transaction information and/or bag location and status information to the online garment service bag issuance database (103), which is dynamically accessible by the third-party service portal, the garment cleaning customer, and the chosen local garment cleaning service provider via various subsystem user interfaces.

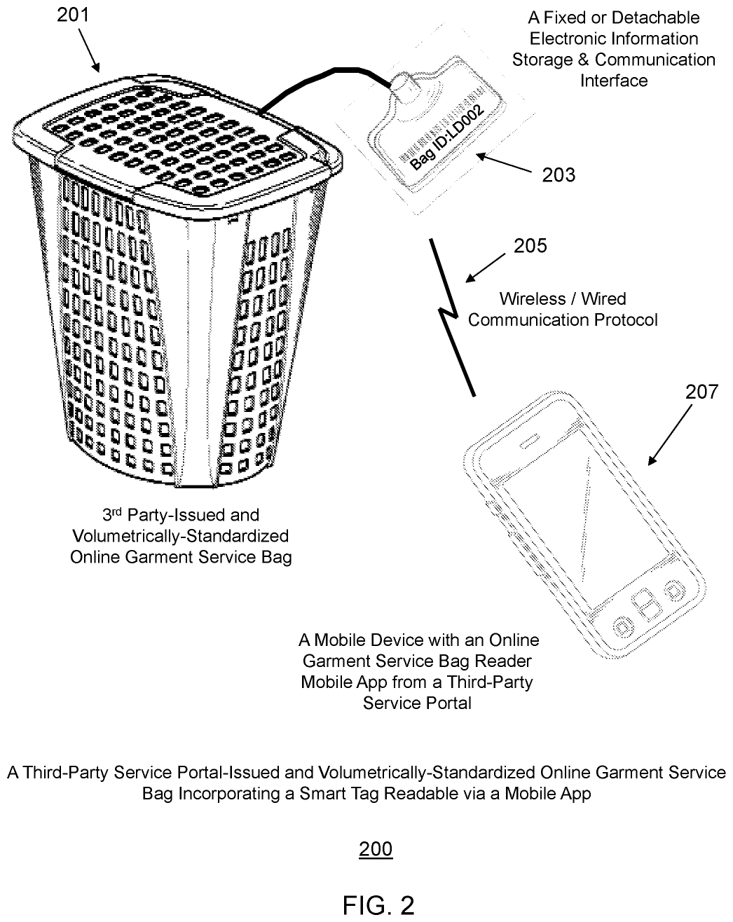

FIG. 2 shows an example (200) of a third-party service portal-issued and volumetrically-standardized online garment service bag (201) incorporating a smart tag (203) or another non-volatile memory storage containing a customer order, a bag owner's ID, and garment cleaning service provider's feedback that are configurable and readable via a mobile application executed on a portable electronic device (207), in accordance with an embodiment of the invention. Preferably, the portable electronic device (207) is operated by a garment cleaning customer or a garment cleaning provider, and integrates a wireless tag reader that utilizes a wireless or wired communication protocol (205) to access, modify, or update garment cleaning service transaction, bag location, and/or service status information stored in the smart tag (203) or in another non-volatile memory storage incorporated into the third-party service portal-issued and volumetrically-standardized online garment service bag (201).

In this example (200) as shown in FIG. 2, the portable electronic device (207) executes a garment cleaning customer-specific user interface mobile app or a garment cleaning provider-specific user interface mobile app, which provides access and data synchronization with the corresponding user interface management modules (e.g. 111, 113 in FIG. 1) and the online garment service bag issuance database (e.g. 103 in FIG. 1) in the third-party service portal-side subsystem (e.g. 101 in FIG. 1). In a preferred embodiment of the invention, the portable electronic device (207) is configured to retrieve or update bag ID's and various garment cleaning service transaction, bag location, and/or service status data parameters stored in the smart tag (203), in another attached non-volatile memory storage, or in the online garment service bag issuance database, as the third-party service portal-issued and volumetrically-standardized online garment service bag (201) is transported back and forth with loaded laundry items between a garment cleaning customer and a chosen independent local garment cleaning provider subscribed to the third-party service portal.

In one embodiment of the invention, an online garment service bag (e.g. 201) may be an electronically-identifiable physical container unit incorporating a fixed or detachable electronic information storage and a communication interface, which can be accessed by another electronic device for information reading, writing, and/or updating. For example, a third-party service portal-issued online garment service bag embeds a non-volatile memory (e.g. Flash memory) storage and one or more wired (e.g. USB, serial port) and/or wireless (e.g. Bluetooth, IEEE 802.11 Standard-based wireless LAN, RFID, NFC, ZigBee) communication interfaces for access by customers' or garment cleaning providers' electronic devices. In another example, a third-party service portal-issued online garment service bag attaches or incorporates an RFID tag, which can be accessed by the customers' or the garment cleaning providers' electronic devices (e.g. smart phones, tablet computers, notebook computers, etc.) that execute online garment service bag reader mobile apps developed by the third-party service portal. In the preferred embodiment of the invention, the non-volatile memory storage or the RFID tag may store or update bag tag ID's, bag-issuance customer information, cleaning transaction information, bag location and status information, and bag unit types.

FIG. 3 shows a screenshot (300) from an independent local garment service provider's user interface for garment cleaning service price bidding, service availability, and business contact updates to the third-party service portal-initiated garment service bag issuance, volumetrically-standardized pricing, and matchmaking system, in accordance with an embodiment of the invention. As shown by the screenshot (300) in FIG. 3, the independent local garment service provider's user interface is generated and displayed by a computer or a portable electronic device executing an independent local garment cleaning service provider's application program or a similar mobile app, which is downloaded from and at least partially controlled by a third-party service portal-originating user interface management module (e.g. 111 in FIG. 1) in a third-party service portal-side subsystem (e.g. 101 in FIG. 1).

In context of the screenshot (300) example, the independent local garment service provider's user interface comprises a portal's marketplace service provider settings menu title bar (301), which displays the name of the independent local garment service provider (i.e. “A-Plus Dry Cleaning, Inc.”), a business address, telephone, payment methods, user review ratings, and operating hours information entry section (303), a business service description entry section (305), and a “submit” button (307) for transmitting and saving updated business information supplied by the independent local garment service provider to the third-party service portal. Furthermore, the independent local garment service provider's user interface also incorporates a third-party service portal-issued garment service bag size acceptance and bidding price definition interface (309), which enables each subscribed independent local garment service provider to accept or reject one or more unit bag types for garment cleaning or repair service offerings.

In this particular screenshot (300) example as shown in FIG. 3, the independent local garment service provider (i.e. “A-Plus Dry Cleaning, Inc.”) accepts “Unit B” and “Unit C” bag types to provide garment wash and dry cleaning services for 35 gallons or 50 gallons-worth of laundry load, respectively, while rejecting “Unit A” bag type that merely contains 20 gallons-worth of laundry load. The independent local garment service provider (i.e. “A-Plus Dry Cleaning, Inc.”) also defines or adjust wash and dry-clean bidding prices per each accepted unit bag type. As shown in FIG. 3, for “Unit B” bag type, the independent local garment service provider (i.e. “A-Plus Dry Cleaning, Inc.”) sets the wash service at $14.05 and the dry-cleaning service at $34.05. For “Unit C” bag type, the independent local garment service provider (i.e. “A-Plus Dry Cleaning, Inc.”) sets the wash service at $22.95 and the dry-cleaning service at $49.95. The volumetric standardization of laundry loads is made possible by the pre-distribution of pre-defined unit bag types by the third-party service portal, which also standardizes and enforces unit bag type-specific pricing definitions and dynamic adjustments from all subscribed independent local garment service providers, even before any professional garment cleaning or repair services are offered by any independent local garment service providers via the third-party service portal.

FIG. 4 shows a screenshot (400) from a potential customer's user interface originating from the third-party service portal-initiated garment service bag issuance, volumetrically-standardized pricing, and matchmaking system, in accordance with an embodiment of the invention. As shown by the screenshot (400) in FIG. 4, the customer user interface is generated and displayed by a computer or a portable electronic device executing a customer user interface application program or a similar mobile app, which is downloaded from and at least partially controlled by a third-party service portal-originating user interface management module (e.g. 113 in FIG. 1) in a third-party service portal-side subsystem (e.g. 101 in FIG. 1).

In context of the screenshot (400) example, the customer user interface comprises a customer's portal marketplace search bar (401), which displays a subset of business provider search results (e.g. 1-3 of 21) for garment cleaning service, and the customer's preferred search location base (403). The customer user interface also displays and allows a garment cleaning customer to select a service location, a search radius, a customer review-verified service provider filter, and particular garment cleaning or repair services offered in a customer search interface section (405). The portal-issued “garment service bag-compliant” checkbox, when checked, ensures that a list of independent local garment cleaning service providers displayed in a provider list section (409) is compliant to the third-party service portal-enforced volumetrically-standardized pricing metric, which accommodates price comparisons to be objective, fair, and accurate across all competitive garment cleaning service offerings among the local garment cleaning service providers subscribed to and listed in the third-party service portal.

Continuing with the embodiment of the invention as shown in FIG. 4, the customer user interface also includes a garment cleaning service provider search result section (409) that lists a plurality of local and independent garment cleaning service providers that satisfy the customer's search criteria from the customer's preferred search location base (403) and the customer search interface section (405). As shown by the screenshot (400) of the customer user interface, the garment cleaning service provider search result section (409) displays three of the twenty-one garment cleaning service providers that have matched the customer's filter criteria. If a potential customer would like to explore other available local garment cleaning provider options, the potential customer may search other providers beyond what is listed in the garment cleaning service provider search results section (409) by clicking on a “More Provider Search Results?” button (411). As displayed in the garment cleaning service provider search result section (409), each listed provider may include business contact information (e.g. phone numbers, street addresses, etc.), customer review ratings generated from the third-party service portal, prices offered per volumetrically-standardized garment service bag types, and the bag types a particular provider accepts.

Furthermore, the customer user interface may further include an online garment service bag order section (407) that activates mailing of the third-party service portal-issued volumetrically-standardized online garment service bags to a potential garment cleaning customer, if the customer shows intention to utilize the third-party service portal to place garment cleaning service orders in the future to one or more independent local garment cleaning service providers subscribed to the third-party service portal. Preferably, the third-party service portal sends a volumetrically-standardized online garment service bag (e.g. “Unit A,” “Unit B,” “Unit C,” or a combination thereof) to a potential garment cleaning customer as a complimentary promotional measure to encourage utilization of the subscribed independent local garment cleaning service providers, after completing an “online garment service bag issuance activity” executed by the online garment service bag issuance and shipment module (e.g. 105 of FIG. 1) and the online garment service bag issuance database (e.g. 103 of FIG. 1), which were described previously in conjunction with FIG. 1. Alternatively, the third-party service portal may charge a fee for the “online garment service bag issuance activity” and the shipment of the volumetrically-standardized online garment service bag to the potential garment cleaning customer.

Once a garment cleaning customer receives one or more volumetrically-standardized online garment service bags from the third-party service portal, the garment cleaning customer can chose a particular independent local garment cleaning service provider from the garment cleaning service provider search result section (409) and schedule a garment service bag pickup (i.e. 413) with a delivery service, or find a nearby garment service bag drop box (i.e. 415) to drop off a loaded online garment service bag to a convenient location in a strip mall or a convenience store, even if the garment cleaning customer decides to not drive to the chosen garment cleaning service provider directly. The volumetrically-standardized online garment service bag issuance and the bag pick-up or drop-off service arrangements initiated and managed by the third-party service portal enables apples-to-apples fair and objective service price comparisons for garment cleaning service offerings, which have been historically murky, excessively subjective, and difficult to produce or enforce objectively-comparable pricing metrics among a plurality of local cleaners.

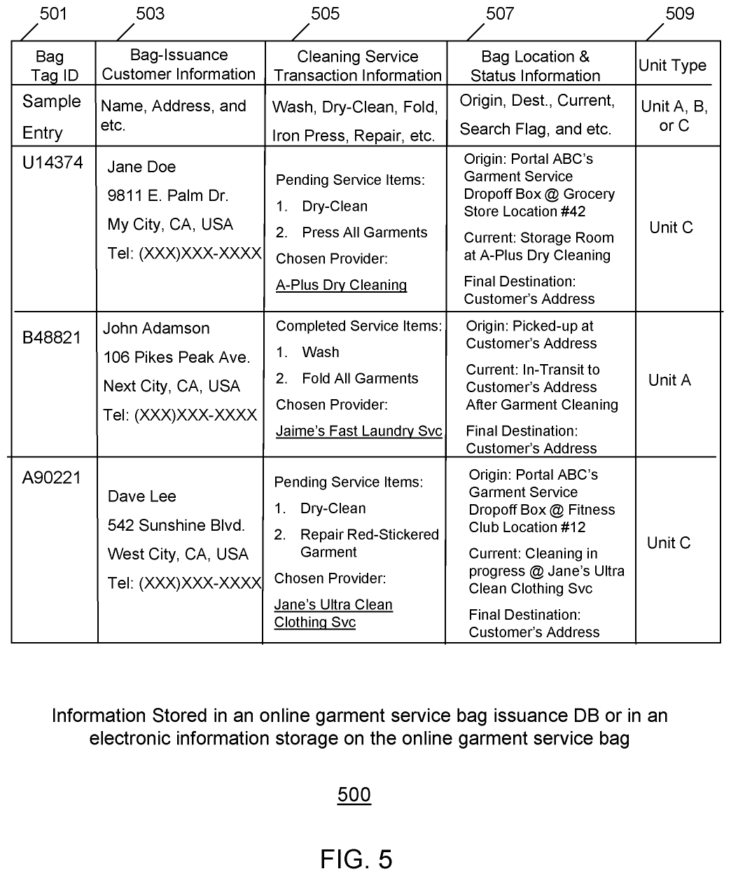

FIG. 5 shows an example (500) of information stored in an online garment service bag issuance database and/or in an electronic information storage and communication interface attached to or integrated into an online garment service bag, in accordance with an embodiment of the invention. In this example (500), the online garment service bag issuance database and/or the electronic information storage and communication interface on the online garment service bag may store and dynamically update bag tag identification information (501), bag-issuance customer information (503), cleaning service transaction information (505), bag location and status information (507), and bag unit type information (509).

In a preferred embodiment of the invention, at least some of these garment service bag-related data parameters may be initialized by the online garment service bag issuance and shipment module (e.g. 105 of FIG. 1) and stored in the online garment service bag issuance database (e.g. 103 of FIG. 1). Subsequently, the garment service bag-related data parameters are dynamically updated over time, as each online garment service bag gets involved in repeated garment cleaning or repair transactions back and forth among the third-party service portal, the garment cleaning customer, and various local garment cleaning service providers subscribed to the third-party service portal.

A customer's electronic device or a local garment cleaning service provider's electronic device, which is configured to access the online garment service bag issuance database or the electronic information storage and communication interface on the online garment service bag, is able to read or update pertinent transaction, status, and/or location information throughout various service procedures and deliveries throughout the lifecycle of each garment cleaning service process. Furthermore, the online garment service bag issuance database (e.g. 103 of FIG. 1) may also compile a lifetime history of transactions, changing customer address or contact information (if any), and bag location and status information for a particular bag tag ID (501), until the online garment service bag associated with the particular bag tag ID is officially discarded from the third-party service portal-side subsystem (e.g. 101 of FIG. 1).

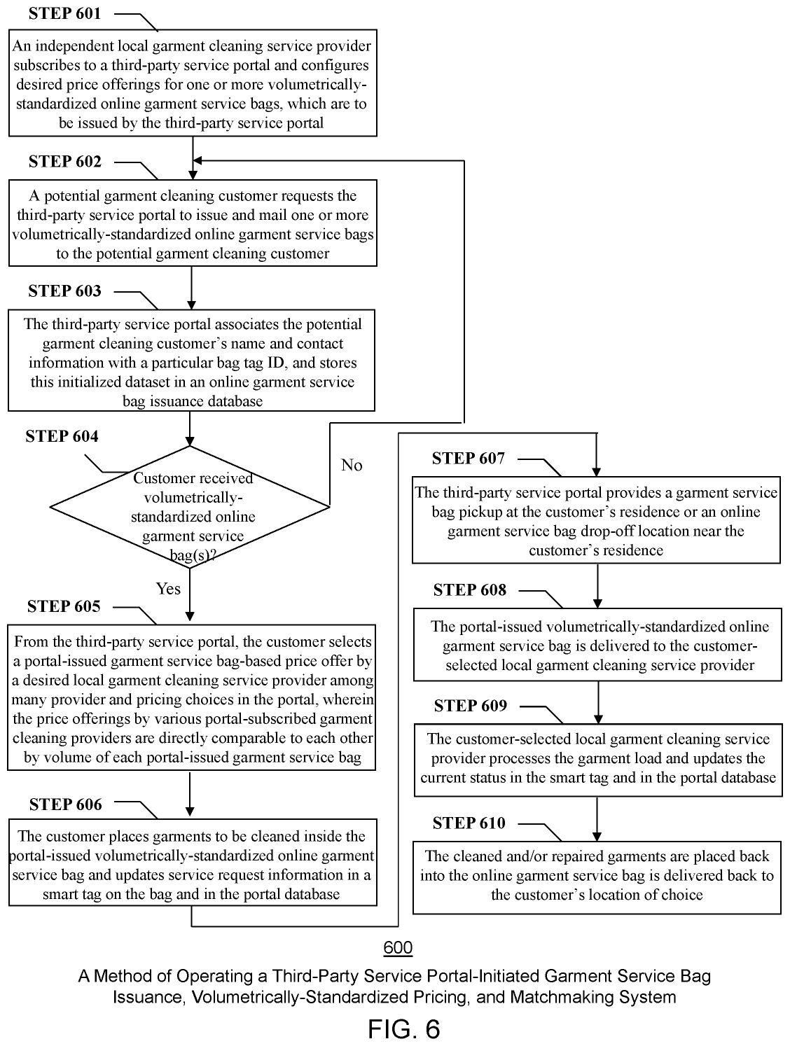

FIG. 6 shows a method (600) of operating a third-party service portal-initiated garment service bag issuance, volumetrically-standardized pricing, and matchmaking system for professional garment cleaning, in accordance with an embodiment of the invention. In this method (600) of operating the system, an independent local garment cleaning service provider subscribes to a third-party service portal and configures desired price offerings for one or more volumetrically-standardized online garment service bags, which are to be issued by the third-party service portal, as shown in STEP 601. Then, a potential garment cleaning customer can log into a customer user interface associated with the third-party service portal, and request the third-party service portal to issue and mail one or more volumetrically-standardized online garment service bags to the potential garment cleaning customer, as shown in STEP 602.

As part of an online garment service bag issuance activity, the third-party service portal associates the potential garment cleaning customer's name and contact information with a particular bag tag ID, and stores this initialized dataset in an online garment service bag issuance database, as shown in STEP 603. Subsequently, as indicated in STEP 604, if the customer did not receive volumetrically-standardized online garment service bags from the third-party service portal, then the system loops back to STEP 602 and waits until the customer's online garment service bag issuance request is executed, processed, and shipped to the customer.

Once the customer receives the volumetrically-standardized online garment service bags from the third-party service portal, then the customer can utilize the customer user interface linked to the third-party service portal to select a portal-issued garment service bag-based price offer by a desired local garment cleaning service provider among many provider and pricing choices in the portal, as shown in STEP 605. As described previously in conjunction with other figures, the price offerings by various portal-subscribed garment cleaning providers are directly comparable to each other by volume of each portal-issued garment service bag due to the volumetric standardization of garment service bags pre-distributed, regulated, and enforced by the third-party service portal prior to any transportations or deliveries of laundry loads between the customer and the desired local garment cleaning service provider.

Continuing with the method (600) in FIG. 6, after selecting the desired local garment cleaning service provider, the customer can place garments to be cleaned inside the portal-issued volumetrically-standardized online garment service bag and update service request information in a smart tag and/or a third-party portal service database, as shown in STEP 606. Then, the third-party service portal provides a garment service bag pickup at the customer's residence or an online garment service bag drop-off location near the customer's residence via the customer user interface linked to the third-party service portal, as shown in STEP 607. Subsequently, the customer allows the portal-issued volumetrically-standardized online garment service bag pickup or drop-off from his or her preferred location, after which the service bag is delivered to the customer-selected local garment cleaning service provider, as shown in STEP 608.

Then, the customer-selected local garment cleaning service provider processes (i.e. dry-cleans, washes, repairs, irons, and/or folds) the garment load and updates the current status in the smart tag and/or in the portal database, as shown in STEP 609. Lastly, the cleaned and/or repaired garments are placed back into the portal-issued volumetrically-standardized online garment service bag, which is subsequently delivered back to the customer's delivery location of choice, as shown in STEP 610.

One or more novel systems and methods for third-party service portal-initiated garment service bag issuance, volumetrically-standardized pricing, garment cleaning service matchmaking, and delivery processing for professional garment cleaning have been disclosed in the descriptions above and corresponding drawings. Various embodiments of the present invention exhibit several advantages over conventional electronic systems and methods for accommodating laundry and dry-cleaning service-related e-commerce transactions, transportation logistics, service pricing analytics, and customer convenience.

For example, an embodiment of the present invention provides a novel third-party service portal-initiated electronic system that enables an Internet portal site to create volumetrically-standardized garment service bags and electronically track those bags through their lifecycles to facilitate, manage, and deliver garment cleaning services between consumers and local garment cleaning service providers.

Furthermore, another embodiment of the present invention provides a novel third-party service portal-initiated electronic system that facilitates and enforces volumetrically-standardized pricing, volumetrically-standardized online garment service bags, and bilateral deliveries of laundry loads or dry-cleaning loads between independent local garment cleaning service providers and customers.

In addition, another embodiment of the present invention provides a method of operating a novel third-party service portal-initiated electronic system to create and manage a robust e-commerce ecosystem of local and independent garment cleaning service providers that benefit from an expanded customer base reached by a third-party Internet portal site, even when no extra marketing expenses are incurred by the local and independent garment cleaning service providers.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A third-party service portal-initiated garment service bag issuance, volumetrically-standardized pricing, and matchmaking system for professional garment cleaning, the system comprising:
a volumetrically-standardized online garment service bag created and issued by a third-party service portal, wherein the volumetrically-standardized online garment service bag is mailed to a garment cleaning customer's physical address upon request by the garment cleaning customer via a customer user interface connected to the third-party service portal;
a third-party service portal-side electronic subsystem in the third-party service portal comprising an online garment service bag issuance and shipment module configured to create, issue, and ship the volumetrically-standardized online garment service bag upon request by the garment cleaning customer, a professional garment cleaning service customer matchmaking module for independent local garment cleaning service providers, a price bidding module for the independent local garment cleaning service providers, a first user interface management module for the independent local garment cleaning service providers, a second user interface management module for the garment cleaning customer, and an online garment service bag issuance database;
a first local garment cleaning service provider subsystem that allows a first independent local garment cleaning service provider to configure a first garment cleaning service fee for the volumetrically-standardized online garment service bag in the third-party service portal;
a second local garment cleaning service provider subsystem that allows a second independent local garment cleaning service provider to configure a second garment cleaning service fee for the volumetrically-standardized online garment service bag in the third-party service portal, wherein the first garment cleaning service fee from the first local garment cleaning service provider subsystem and the second garment cleaning service fee from the second local garment cleaning service provider subsystem are directly comparable per unit bag type of loaded garments for objectively determining loaded garment cleaning service price differences;
a customer subsystem configured to generate the customer user interface connected to the third-party service portal, wherein the customer user interface allows the garment cleaning customer to compare the first garment cleaning service fee and the second garment cleaning service fee per unit bag type of loaded garments in the volumetrically-standardized online garment service bag, before selecting a chosen independent local garment cleaning provider to initiate transportation of the volumetrically-standardized online garment service bag loaded with garments;
a delivery provider subsystem configured to transport the volumetrically-standardized online garment service bag between the garment cleaning customer and the chosen independent local garment cleaning provider; and
a data network operatively connecting the third-party service portal-side electronic subsystem, the first local garment cleaning service provider subsystem, the second local garment cleaning service provider subsystem, the customer subsystem, and the delivery provider subsystem, wherein at least one subsystem is executed on a CPU and a memory unit of a computer server or a portable electronic device.

2. The system of claim 1, wherein the online garment service bag issuance and shipment module dynamically associates the volumetrically-standardized online garment service bag with a unique bag tag ID, a unit type, and bag-issuance customer information in the online garment service bag issuance database as part of a bag-issuance activity prior to mailing the volumetrically-standardized online garment service bag to the garment cleaning customer, who in turn utilizes the volumetrically-standardized online garment service bag to transport laundry load to one of the independent local garment cleaning service providers.

3. The system of claim 1, wherein the professional garment cleaning service customer matchmaking module is configured to synthesize, match, and store client service transaction information between the garment cleaning customer and a customer-selected independent local garment cleaning service provider in the online garment service bag issuance database based on customer-selected parameters in the customer user interface, which is connected to the third-party service portal.

4. The system of claim 1, wherein the price bidding module allows each independent local garment cleaning service provider to initialize or adjust a garment cleaning service fee competitively based on comparisons with other providers' pricing information, which is universally volumetrically-standardized per unit bag type of loaded garments in the volumetrically-standardized online garment service bag issued and managed by the third-party service portal.

5. The system of claim 1, wherein the online garment service bag issuance database stores initialized or updated bag tag ID information, bag-issuance customer information, cleaning service transaction information, bag location and status information, and unit type information in the computer server or in another electronic device connected to the data network.

6. The system of claim 1, further comprising an electronic wireless tag with a non-volatile data storage incorporated into or attached to the volumetrically-standardized online garment service bag.

7. The system of claim 6, wherein the electronic wireless tag is configured to store or retrieve at least one of bag tag identification (ID) information, bag-issuance customer information, cleaning service transaction information, bag location and status information, and bag unit type information by utilizing a portable wireless tag reader to access the non-volatile data storage of the electronic wireless tag.

8. The system of claim 7, further comprising the portable wireless tag reader executing a mobile app configured to read information from or write information into the non-volatile data storage of the electronic wireless tag on the volumetrically-standardized online garment service bag.

9. The system of claim 8, wherein the portable wireless tag reader is a smart phone, a tablet computer, or a notebook computer configured to communicate with the electronic wireless tag via Bluetooth or radio frequency identification (RFID)-compliant wireless communication protocol.

10. The system of claim 8, further comprising a display screen in the portable wireless tag reader that displays a computerized user interface originating from at least one of the mobile app, the third-party service portal-side subsystem, the first local garment cleaning service provider subsystem, the second local garment cleaning service provider subsystem, the delivery provider subsystem, and the customer subsystem.
